(19) United States
(12) Patent Application Publication
(10) Pub. No.: US 2003/0052527 A1
(43) Pub. Date: Mar. 20, 2003

(54) Vehicle seat bottom support grid and method for making same

(75) Inventor: Vanco Naumovski, Shelby Township, MI (US)

Correspondence Address: BROOKS & KUSHMAN, 1000 TOWN CENTER 22ND FL, SOUTHFIELD, MI, 48075

(73) Assignee: UTICA ENTERPRISES, INC., Shelby Township, MI

(21) Appl. No.: 09/955,638

(22) Filed: Sep. 18, 2001

(51) Int. Cl. B23K 26/22

(52) U.S. Cl. 297/452.56; 219/121.64

(57) ABSTRACT

A support grid (20) and method for making the support grid to support a vehicle seat bottom foam bun (24) utilizes a peripheral metallic wire (28) and sets of longitudinally and laterally extending metallic straps (38, 48) that are secured by end welds (58) to the peripheral wire and by autogenous intermediate welds (60) to each other. The end welds (58) can also be autogenous welds and as with the autogenous intermediate welds (60) can be made by laser welding or electric resistance welding.

### BACKGROUND OF THE INVENTION

1. Field of the Invention

This invention relates to a support grid for supporting a foam bun on a seat bottom of a vehicle seat, and the invention also relates to a method for making the support grid.

2. Background Art

Current vehicle production seats include seat bottoms having a foam bun that is supported on a metallic wire grid that includes a peripheral wire of a round cross section and longitudinally and laterally extending wires of round cross sections that are welded to the peripheral wire and to each other, usually by metallic inert gas (MIG) welding. Such MIG welding conventionally utilizes a consumable electrode that can result in weld spatter. Also, the round cross sections of the longitudinally and laterally extending wires of the support grid result in line contact with the foam bun of the seat bottom, and the foam thus deforms as the vehicle seat occupant or occupants assume a seated position.

Prior art references noted during an investigation conducted in connection with the invention include U.S. Pat. No. 5,001,324 Aiello et al.; U.S. Pat. No. 5,288,134 Hewko et al.; U.S. Pat. No. 5,382,770 Black et al.; U.S. Pat. No. 5,762,397 Venuto et al.; U.S. Pat. No. 6,034,349 Ota; and U.S. Pat. No. 6,087,625 Iso

### SUMMARY OF THE INVENTION

An object of the present invention is to provide an improved support grid for supporting a foam bun on a seat bottom frame of a vehicle seat.

In carrying out the above object, the support grid includes a peripheral metallic wire of a unitary construction with a round cross section and having a front portion, a rear portion and a pair of side portions that cooperate to define a closed shape generally corresponding to the peripheral shape of the foam bun and having a longitudinal direction extending between the front and rear portions and a lateral direction extending between the pair of side portions. A set of longitudinally extending metallic straps of the grid are spaced laterally with respect to each other. Each longitudinally extending strap includes front and rear ends having end junctions with the front and rear peripheral metallic wire. Each longitudinally extending strap also includes an intermediate portion that extends between its front and rear ends. A set of laterally extending metallic straps of the support grid are spaced longitudinally with respect to each other. Each laterally extending strap includes a pair of ends having respective end junctions with the pair of side portions of the peripheral metallic wire. Each laterally extending strap also includes an intermediate portion that extends between its ends in a perpendicular relationship to the intermediate portions of the longitudinally extending metallic straps and having intermediate junctions with the intermediate portions of the longitudinally extending straps. The metallic straps of both the longitudinally and laterally extending sets each have a rectangular cross section with a larger width than thickness to provide surface support of the foam bun. End welds secure the ends of the metallic straps of both sets to the peripheral wire at the end junctions. Autogenous intermediate welds secure the intermediate portions of the longitudinally extending metallic straps to the intermediate portions of the laterally extending metallic straps at their intermediate junctions.

The construction of the support grid with the longitudinally and laterally extending metallic strap advantageously provides increased surface support of the foam bun without additional weight as compared to grids of crossing round wires, and the autogenous intermediate welds eliminate problems associated with securement by welding that utilizes consumable electrodes or otherwise adds material to the welds.

The end welds that secure the ends of the metallic straps of both sets to the peripheral wire at the end junctions are preferably autogenous welds. The autogenous end welds of the straps to the peripheral wire and the autogenous intermediate welds of the intermediate strap portions to each other can be either laser welds or electric resistance welds.

As disclosed, the vehicle seat bottom foam bun support grid has a longitudinal dimension between the front and rear portions of the peripheral wire that is less than the lateral dimension between the pair of side portions of the peripheral wire so as to be usable with a bench type seat for accommodating a plurality of passengers.

In the preferred construction of the vehicle seat bottom foam bun, the peripheral wire has a round cross section with a diameter in the range of ⅛ to ¼ of an inch. Furthermore, the longitudinally and laterally extending straps each have a rectangular cross section with a width in the range of ⅜ to ⅝ of an inch and a thickness in the range of 0.020 to 0.060 of an inch. In addition, the sets of longitudinally and laterally extending straps have the straps thereof located on centers spaced from each other in the range of 1.5 to 2.5 inches. The most preferred construction of the support grid has the rectangular cross section of the longitudinally and laterally extending straps each provided with a width of about ½ inch and a thickness of either about 0.27 of an inch for lightweight constructions and 0.047 of an inch for more heavy duty constructions. Furthermore, the sets of longitudinally and laterally extending straps most preferably have the straps thereof located on centers spaced from each other about two inches.

Another object of the present invention is to provide an improved method for making a support grid for supporting a foam bun on a vehicle seat bottom frame.

In carrying out the immediately preceding object, the method for making the support grid is performed by forming a unitary wire of a round cross section into a peripheral metallic wire having a front portion, a rear portion and a pair of side portions that cooperate to define a closed shape generally corresponding to the peripheral shape of the foam bun and having a longitudinal direction extending between the front and rear portions and a lateral direction extending between the pair of side portions. A set of longitudinally extending metallic straps are laterally spaced from each other with each including front and rear ends having end junctions with the front and rear portions of the peripheral metallic wire and with each including an intermediate portion that extends between its front and rear ends. A set of laterally extending metallic straps are longitudinally spaced from each other with each including a pair of ends having respect end junctions with the pair of side portions of the peripheral metallic wire and with each including an intermediate portion that extends between its ends in a perpendicular relationship to the intermediate portions of the longitudinally extending metallic straps and having intermediate junctions with the intermediate portions of the longitudinally extending straps. The ends of the metallic straps of both sets are welded to the peripheral wire at the end junctions, and the intermediate portions of the longitudinally and laterally extending straps are autogenously welded to each other at their intermediate junctions.

The ends of the metallic straps of both sets are preferably autogenously welded to the peripheral wire at the end junctions. The method for making the support grid is performed by using laser welding or electric resistance welding to provide the autogenous welding of the metallic strap ends to the peripheral wire at the end junctions and to provide the autogenous welding of the intermediate portions of the longitudinally and laterally extending metallic straps to each other at their intermediate junctions.

The objects, features and advantages of the present invention are readily apparent from the following detailed description of the preferred embodiment when taken in connection with the accompanying drawings.

### BRIEF DESCRIPTION OF THE DRAWINGS

FIG. 1 is a side elevational view of a vehicle seat that includes a support grid constructed in accordance with the present invention to support a foam bun on a seat bottom frame of the seat.

FIG. 2 is a top plan of the support grid taken along the direction of line 2-2 in FIG. 1.

FIG. 3 is a view that illustrates the manner in which a peripheral metallic wire is formed as a portion of the support grid.

FIG. 4 is a sectional view taken along the direction of line 4-4 in FIG. 2 to illustrate autogenous end welds that secure ends of longitudinally extending metallic straps to the peripheral wire.

FIG. 5 is a sectional view taken along the direction of line 5-5 in FIG. 2 to illustrate end welds that secure the ends of laterally extending metallic straps to the peripheral wire.

FIGS. 6a and 6b are partial sectional views respectively taken along the direction of lines 6a-6a and 6b-6b in FIG. 2 to illustrate autogenous intermediate welds that secure intermediate portions of the longitudinally extending metallic straps to intermediate portions of the laterally extending metallic straps.

FIG. 7 is a view that illustrates the manner in which the autogenous welds can be made by laser welding.

FIG. 8 is a view that illustrates the manner in which the autogenous welds can be made by electric resistance welding.

### DETAILED DESCRIPTION OF THE PREFERRED EMBODIMENT

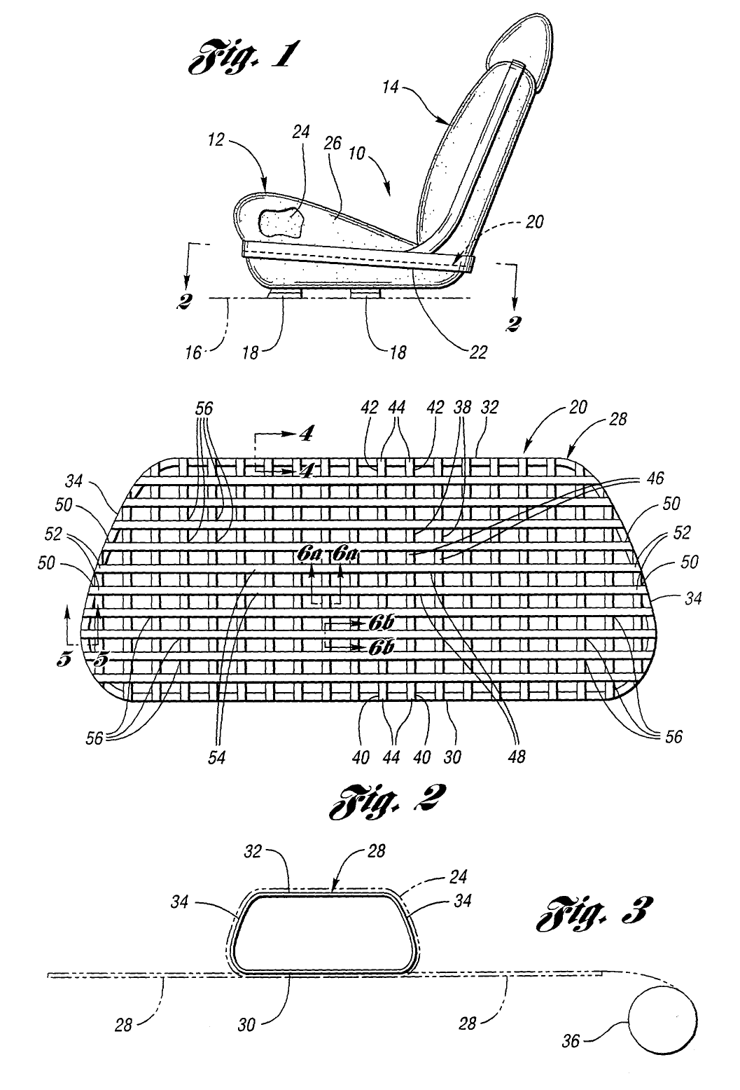

With reference to FIG. 1, a vehicle seat generally indicated by 10 includes a seat bottom 12 and a seat back 14 with the seat shown mounted on a vehicle floor 16 by mounts 18 that may be either of the fixed type such as utilized with a fixed rear seat or of the adjustable type for permitting front to rear longitudinally adjustment such as utilized with a front seat. A support grid 20 constructed in accordance with this invention is mounted by a seat bottom frame 22 to support a seat bottom foam bun 24 that is covered by upholster material 26 in a conventional manner. The construction of the support grid 20 follows with reference to the other drawings and is integrated with the description of the method for making the support grid so as to facilitate an understanding of all aspects of the invention.

As illustrated in FIG. 2, the seat bottom foam bun support grid 20 of the invention includes a peripheral metallic wire 28 of a round cross section and having a front portion 30, a rear portion 32, and a pair of side portions 34 that cooperate to define a closed shape generally corresponding to the peripheral shape of the foam bun 24 as shown in FIG. 3. The peripheral wire 28 has a longitudinal direction extending between its front and rear portions 30 and 32 and has a lateral direction extending between its pair of side portions 34.

As illustrated in FIG. 3, the peripheral wire 28 is formed from a wire length such as one that is drawn from a wire roll 36 and then cut and, after forming of the wire length to the shape of the peripheral wire shown, the ends of the wire are secured to each other by welding in any suitable manner.

As illustrated in FIG. 2, the support grid 20 includes a set of longitudinally extending metallic straps 38 that are spaced laterally with respect to each other. Each longitudinally extending metallic strap 38 includes front and rear ends 40 and 42 having end junctions 44 with the front and rear portions 30 and 32 of the peripheral metallic wire 38. Each longitudinally extending metallic strap 38 also has an intermediate portion 46 that extends between its front and rear ends 40 and 42.

With continuing reference to FIG. 2, the support grid 20 also has a set of laterally extending metallic straps 48 that are spaced longitudinally with respect to each other. Each laterally extending strap 48 includes a pair of ends 50 having respective end junctions 52 with the pair of side portions 34 of the peripheral metallic wire 28. Each laterally extending strap 48 also has an intermediate portion 54 that extends between its ends 52 in a perpendicular relationship to the intermediate portions 46 of the longitudinally extending metallic straps 38, and the laterally extending intermediate portions 54 also have each immediate junctions 56 with the intermediate portions 46 of the longitudinally extending metallic straps.

Both the longitudinally extending metallic straps 38 and the laterally extending metallic straps 48 may have their ends 40, 42 and 50 partially or fully wrapped around the peripheral wire to enhance the securement and prevent the strap ends from cutting the foam bun.

As illustrated in FIGS. 6a and 6b, the metallic straps 38 and 48 of the longitudinally and laterally extending sets each has a rectangular cross section with a larger width than thickness to provide surface support of the associated seat bottom foam bun without adding excessive weight to the vehicle.

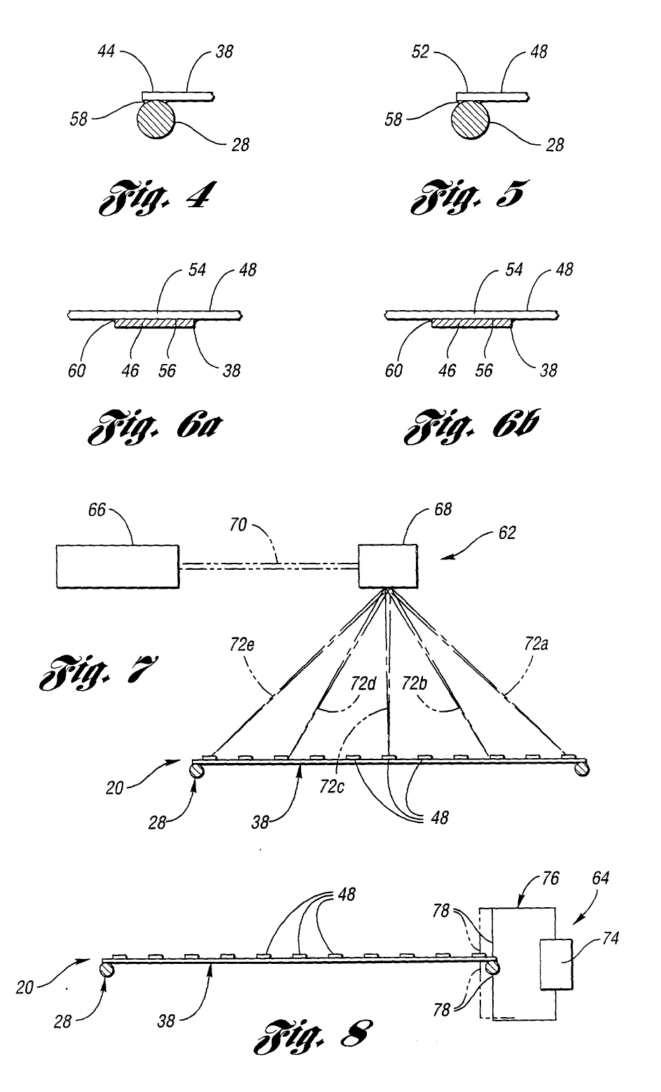

With reference to FIGS. 4 and 5, end welds 58 that are preferably autogenous secure the ends of both the longitudinally and laterally extending metallic straps 38 and 48 to the metallic peripheral wire 28 at their associated end junctions 44 and 52. Furthermore, as illustrated in FIGS. 6a and 6b, autogenous intermediate welds 60 secure the intermediate portions 46 of the longitudinally extending metallic straps 38 to the intermediate portions 54 of the laterally extending metallic straps 48 at their intermediate junctions 56 to thereby integrate all of the metallic straps and the peripheral wire in association with the autogenous end welds into an interconnected support grid. While the end welds 58 do not necessarily have to be autogenous welds, as required for the intermediate welds 60, it is preferable for the end welds to also be autogenous so as to eliminate problems such as weld spatter associated with MIG welding.

Both the preferred autogenous end welds 58 illustrated in FIGS. 4 and 5 and the autogenous intermediate welds 60 illustrated in FIGS. 6a and 6b are thus made without any introduction of a consumable welding electrode or other welding material added to the weld other than the metallic strap material of the straps being welded to each other. The autogenous welds can be manufactured by laser welding apparatus 62 illustrated in FIG. 7 or by electric resistance welding apparatus 64 illustrated in FIG. 8, as are hereinafter more fully described, to provide either laser welds or electric resistance welds between the straps and the metallic peripheral wire and between the straps themselves.

As illustrated in FIG. 2, the support grid 20 has a laterally elongated shape with a longitudinal dimension between the front and rear portions 30 and 32 of the peripheral wire 28 that is less than the lateral dimension between the pair of side portions 34 of the peripheral wire so as to be usable with a bench type seat for accommodating a plurality of seat occupants. The foam bun 24 has a corresponding shape that is elongated in a lateral direction relative to its front to rear longitudinal direction as was previously described in connection with FIG. 3. While this bench type seat usage is preferred for the support grid, it can also be used with individual seats that each support a single seat occupant.

With combined reference to FIGS. 2, 4, 5, 6a and 6b, the peripheral wire 28 is preferably made from cold rolled steel and has a round cross section with a diameter that is preferably in the range of ⅛ to ¼ of an inch. Furthermore, the longitudinally and laterally extending metallic straps 38 and 48 as illustrated in FIGS. 6a and 6b are also preferably made from cold rolled steel and have a rectangular cross section with a width preferably in the range of ⅜ to ⅝ of an inch and most preferably about ½ inch, and the straps have a thickness in the range of about 0.20 to 0.60 of an inch and most preferably either about 0.027 of an inch for lightweight constructions and 0.047 of an inch for heavy duty constructions. Furthermore, the sets of longitudinally and laterally extending metallic straps 38 and 48 have their straps located on centers spaced from each other in the range of about 1.5 to 2.5 inches, and most preferably on centers that are spaced from each other about 2 inches in order to provide a good compromise between adequate surface support of the foam and a lightweight construction.

As illustrated in FIG. 7, the laser welding apparatus 62 includes a laser generator 66 and a remote optical head 68 which both directs and focuses a laser beam 70 to provide sequential laser welding beams 72ₐ, 72_{b}, 72_{c}, 72_{d} and 72ₑ. These laser beams are focused and directed to the end junctions and intermediate junctions previously described to provide autogenous laser welds of the straps to the peripheral wire and to each other at the end junctions and the intermediate junctions. The type of remote laser head 68 utilized may be as disclosed by U.S. Pat. No. 5,561,544 Macken and U.S. Pat. No. 6,078,420 Macken, the entire disclosures of which are hereby incorporated by reference.

As illustrated in FIG. 8, the electric resistance welding apparatus 64 includes a welding head 74 for providing an electric voltage to a clamp 76 whose clamping portions 78 clamp the end junctions as shown by solid line representation to provide the autogenous end welds and clamp the intermediate junctions as shown by phantom line representation to provide the autogenous intermediate welds. Upon such clamping, an electrical voltage applied to the junctions forms the autogenous welds.

While the preferred mode for practicing the invention has been described in detail, those familiar with the are to which this invention relates will recognize various ways for practicing the invention as defined by the following claims.

What is claimed is:

1. A support grid for supporting a foam bun on a seat bottom frame of a vehicle seat, comprising:
a peripheral metallic wire of unitary construction with a round cross section and having a front portion, a rear portion and a pair of side portions that cooperate to define a closed shape generally corresponding to the peripheral shape of the foam bun and having a longitudinal direction extending between the front and rear portions and a lateral direction extending between the pair of side portions;
a set of longitudinally extending metallic straps that are spaced laterally with respect to each other, each longitudinally extending strap including front and rear ends having end junctions with the front and rear portions of the peripheral metallic wire, and each longitudinally extending strap also including an intermediate portion that extends between its front and rear ends;
a set of laterally extending metallic straps that are spaced longitudinally with respect to each other, each laterally extending strap including a pair of ends having respective end junctions with the pair of side portions of the peripheral metallic wire, and each laterally extending strap also including an intermediate portion that extends between its ends in a perpendicular relationship to the intermediate portions of the longitudinally extending metallic straps and having intermediate junctions with the intermediate portions of the longitudinally extending straps;
the metallic straps of both the longitudinally and laterally extending sets each having a rectangular cross section with a larger width than thickness to provide surface support of the foam bun;
end welds that secure the ends of the metallic straps of both sets to the peripheral wire at the end junctions; and
autogenous intermediate welds that secure the intermediate portions of the longitudinally extending metallic straps to the intermediate portions of the laterally extending metallic straps at their intermediate junctions.

2. A vehicle seat bottom foam bun support grid as in claim 1 wherein the end welds of the metallic strap ends to the peripheral wire are autogenous end welds.

3. A vehicle seat bottom foam bun support grid as in claim 2 wherein the autogenous end welds of the strap ends to the peripheral wire and the autogenous intermediate welds of the intermediate strap portions to each other are selected from the group consisting of laser welds and electric resistance welds.

4. A vehicle seat bottom foam bun support grid as in claim 1 which has a longitudinal dimension between the front and rear portions of the peripheral wire that is less than the lateral dimension between the pair of side portions of the peripheral wire so as to be usable with a bench type seat for accommodating a plurality of seat occupants.

5. A vehicle seat bottom foam bun support grid as in claim 1 wherein the peripheral wire has a round cross section with a diameter in the range of ⅛ to ¼ of an inch, the longitudinally and laterally extending straps each having a rectangular cross section with a width in the range of ⅜ to ⅝ of an inch and a thickness in the range of 0.020 to 0.060 of an inch, and the sets of longitudinally and laterally extending straps having the straps thereof located on centers spaced from each other in the range of 1.5 to 2.5 inches.

6. A vehicle seat bottom foam bun support grid as in claim 1 wherein the rectangular cross section of the longitudinally and laterally extending straps each has a width of about ½ inch and a thickness selected from the group consisting of 0.027 and 0.047 of an inch, and the sets of longitudinally and laterally extending straps having the straps thereof located on centers spaced from each other about 2 inches.

7. A support grid for supporting a foam bun on a seat bottom frame of a vehicle seat, comprising:
a peripheral metallic wire of unitary construction with a round cross section with a diameter in the range of ⅛ to ¼ of an inch and having a front portion, a rear portion and a pair of side portions that cooperate to define a closed shape generally corresponding to the peripheral shape of the foam bun and having a longitudinal direction extending between the front and rear portions and a lateral direction extending between the pair of side portions;
a set of longitudinally extending metallic straps that are spaced laterally with respect to each other, each longitudinally extending strap including front and rear ends having end junctions with the front and rear portions of the peripheral metallic wire, and each longitudinally extending strap also including an intermediate portion that extends between its front and rear ends;
a set of laterally extending metallic straps that are spaced longitudinally with respect to each other, each laterally extending strap including a pair of ends having respective end junctions with the pair of side portions of the peripheral metallic wire, and each laterally extending strap also including an intermediate portion that extends between its ends in a perpendicular relationship to the intermediate portions of the longitudinally extending metallic straps and having intermediate junctions with the intermediate portions of the longitudinally extending straps;
the metallic straps of both the longitudinally and laterally extending sets each having a rectangular cross section with a width in the range of ⅜ to ⅝ of an inch and a thickness in the range of 0.0020 to 0.60 of an inch to provide surface support of the foam bun;
autogenous end welds selected from the group consisting of laser welds and electric resistance welds that secure the ends of the metallic straps of both sets to the peripheral wire at the end junctions; and
autogenous intermediate welds selected from the group consisting of laser welds and electric resistance welds that secure the intermediate portions of the longitudinally extending metallic straps to the intermediate portions of the laterally extending metallic straps at their intermediate junctions.

8. A method for making a support grid for supporting a foam bun on a vehicle seat bottom frame, comprising:
forming a unitary wire of a round cross section into a peripheral metallic wire having a front portion, a rear portion and a pair of side portions that cooperate to define a closed shape generally corresponding to the peripheral shape of the foam bun and having a longitudinal direction extending between the front and rear portions and a lateral direction extending between the pair of side portions;
laterally spacing a set of longitudinally extending metallic straps each of which includes front and rear ends having end junctions with the front and rear portions of the peripheral metallic wire and each of which includes an intermediate portion that extends between its front and rear ends;
longitudinally spacing a set of laterally extending metallic straps each of which includes a pair of ends having respective end junctions with the pair of side portions of the peripheral metallic wire and each of which includes an intermediate portion that extends between its ends in a perpendicular relationship to the intermediate portions of the longitudinally extending metallic straps and having intermediate junctions with the intermediate portions of the longitudinally extending straps;
autogenously welding the ends of the metallic straps of both sets to the peripheral wire at the end junctions; and
autogenously welding the intermediate portions of the longitudinally and laterally extending metallic straps to each other at their intermediate junctions.

9. A method for making a support grid for supporting a foam bun on a vehicle seat bottom frame as in claim 9 wherein the ends of the metallic straps of both sets are autogenously welded to the peripheral wire at the end junctions.

10. A method for making a support grid for supporting a foam bun on a vehicle seat bottom frame as in claim 9 wherein both the autogenous welding of the metallic strap ends to the peripheral wire at the end junctions and the autogenous welding of the intermediate portions of the longitudinally and laterally extending metallic straps to each other is performed by the group selected from laser welding and electric resistance welding.
